(19) United States
(12) Patent Application Publication
(10) Pub. No.: US 2007/0014824 A1
(43) Pub. Date: Jan. 18, 2007

(54) Mosquito control method

(76) Inventors: Mark D. Shaw, Ponte Vedra Beach, FL (US); J. Tad Heyman, Atlantic Beach, FL (US); Laurence M. Bierce, Steinhatchee, FL (US)

Correspondence Address: ROGERS TOWERS, P.A., 1301 RIVERPLACE BOULEVARD, SUITE 1500, JACKSONVILLE, FL, 32207, US

(21) Appl. No.: 11/488,210

(22) Filed: Jul. 18, 2006

Related U.S. Application Data
(60) Provisional application No. 60/700,277, filed on Jul. 18, 2005.

(51) Int. Cl. A01N 25/00

(52) U.S. Cl. 424/405

(57) ABSTRACT

Mosquito larvae control is accomplished by providing an anti-microbial carrier member that is placed in the standing water that serves as breeding grounds, whereby the concentration of bacteria and other microbial organisms that serve as food for the larvae is severely reduced or eradicated. By eradicating the food supply, the mosquito larvae population is killed off. The anti-microbial agent is chosen and is adhered to, combined with, impregnated in, contained in the carrier member such that the anti-microbial agent does not leach, dissolve, or permeate into the water.

This application claims the benefit of U.S. Provisional Patent Application Ser. No. 60/700,277, filed Jul. 18, 2005.

### BACKGROUND OF THE INVENTION

This invention relates generally to methods and means for controlling mosquito populations, and more particularly relates to such methods and means that address mosquito larvae in standing water.

Mosquito control undertaken by governmental bodies to improve the quality of life in communities is a time consuming and expensive endeavor. Mosquitoes deposit eggs in standing, stagnant or extremely low rate-of-flow water, with the eggs hatching and becoming larvae prior to becoming mature insects. The larvae subsist on bacteria, plankton, single cell plant life, algae and the like present in the standing water. Mosquito population numbers and frequency of birth cycles is dependent on multiple factors, the primary factor being the amount and frequency of rainfall. The most common approach to the mosquito control problem involves airborne dispersion of pesticides or other materials that kill the mosquitoes, larvae or eggs upon contact, or that disrupt the mosquito life cycle in some manner. The dispersal usually must be repeated often during mosquito season. Detrimental environmental effects and the safety and comfort of citizens in the area must be taken into account when determining the type and amount of anti-mosquito agent used, as well as the frequency of application. These concerns limit the effectiveness of current mosquito control programs. Another method involves dispersal of chemical tablets into stagnant water, such as water retained in the catch basins of man-made storm water drainage systems. This method is problematic in that the water is contaminated by the chemical treatment. A more exotic approach employs placement of fish into lakes and ponds to eat the mosquito larvae.

It is an object of this invention to provide a method of controlling mosquito populations by safely removing the food sources in standing water eaten by developing mosquito larvae, thereby starving the larvae to death and preventing their transformation into adult mosquitoes. It is a further object to accomplish this by utilizing anti-microbial agents to eradicate the bacteria and other microbial organisms that serve as the food source for the mosquito larvae. It is a further object to accomplish this by providing a carrier medium that is deposited and remains in the breeding water, the anti-microbial agent being bound to or retained by the carrier medium such that there is no leaching or dispersal of anti-microbial agent into the water.

### SUMMARY OF THE INVENTION

Control of mosquito populations is accomplished by placing an anti-microbial medium in standing water that serves as a hatching and breeding ground for mosquito larvae, whereby the concentration of bacteria and other microbial organisms that serve as food for the larvae is severely reduced or completely eradicated. By eradicating the food supply, the mosquito larvae population is killed off by starvation. The anti-microbial agent is adhered to, combined with, impregnated in, or contained in carrier materials that float on or are submerged in the standing water, and is chosen such that no leaching, dispersal or migration of the anti-microbial agent into the water occurs.

### DETAILED DESCRIPTION OF THE INVENTION

The invention comprises a method of controlling mosquito populations through eradication of mosquito larvae in standing water by starvation prior to their maturation into adult mosquitoes. The method comprises placing a carrier member comprising an anti-microbial agent in the body of standing water, the carrier member being a solid, a fabric, a sponge, a filter or any other suitable material or body onto or within which the anti-microbial agent is incorporated. Preferably the carrier member floats on the surface of the water, and is provided with depending strips or members that extend down into the water. Alternatively, the carrier member could be fully submerged in the water.

The anti-microbial agent may be any of many suitable compositions, such as for example but not limited to an organosilane antimicrobial agent as disclosed in U.S. Pat. No. 5,954,869, the disclosure of which is incorporated herein by reference, which is suitably bonded, adhered, grafted, impregnated, contained within, or otherwise joined to the carrier member. The term anti-microbial is meant herein to include any compound, product, composition, article, etc., that reduces the growth and proliferation of microbial organisms, including but not limited to bacteria, viruses, protozoa, molds and the like. The anti-microbial agent is stable in water and does not dissolve, leach or permeate into the water, but instead kills the microbes by direct contact. Because of this method of eradication, the surface area and the amount of interstitial spaces should be maximized to increase the likelihood of contact with the microbes. The amount of anti-microbial agent, usually directly related to the size of the carrier member, is chosen to correspond to the amount of standing water in a given location. Multiple carrier members will be utilized for large amounts of standing water.

Over a relatively short period of time the anti-microbial agent eradicates the microbial organisms in the body of water, effectively removing the food supply for the mosquito larvae. Without sufficient food, the larvae die. Because the anti-microbial agent is adhered to, impregnated or otherwise joined to the carrier material, the effectiveness of the device is long-lasting and does not rapidly diminish over time, as is the result with chemical applications, and is not detrimental to the environment.

The method may also include the step of incorporating barley straw into, within or adjacent to the carrier body for placement into the standing water, as barley straw is known to prevent the development of algae in standing water, another food source for the mosquito larvae.

It is contemplated that equivalents and substitutions for certain elements above may be obvious to those skilled in the art, and therefore the true scope and definition of the invention is to be as set forth in the following claims.

We claim:

1. A method of controlling mosquitoes comprising the step of eradicating the microbial food sources in standing water mosquito breeding grounds by placing an anti-microbial agent into the standing water.

2. The method of claim 1, further comprising the steps of providing a carrier member for said anti-microbial agent, and placing said carrier member into the standing water.

3. The method of claim 2, further comprising the step of choosing an anti-microbial agent that does not leach, dissolve or permeate into the standing water.

4. The method of claim 3, further comprising the step of incorporating barley straw into said carrier member.

5. The method of claim 3, further comprising the step of placing barley straw into the standing water.

6. A method of destroying mosquito larvae in standing water comprising the steps of providing a carrier member comprising an anti-microbial agent and placing said carrier member into the standing water to eradicate microbial food sources, wherein said anti-microbial agent is chosen from the group of anti-microbial agents that do not leach, dissolve or permeate into the standing water.

7. The method of claim 6, further comprising the step of adhering said anti-microbial agent to said carrier member.

8. The method of claim 6, further comprising the step of incorporating barley straw into said carrier member.

9. The method of claim 6, further comprising the step of placing barley straw into the standing water.

10. A method of destroying mosquito larvae in standing water comprising the steps of providing a carrier member comprising an anti-microbial agent and placing said carrier member into the standing water to eradicate microbial food sources, wherein said anti-microbial agent is retained by said carrier member such that said anti-microbial agent does not leach, dissolve or permeate into the standing water.

11. The method of claim 10, further comprising the step of adhering said anti-microbial agent to said carrier member.

12. The method of claim 10, further comprising the step of incorporating barley straw into said carrier member.

13. The method of claim 10, further comprising the step of placing barley straw into the standing water.
